(19) United States
(12) Patent Application Publication
(10) Pub. No.: US 2015/0347651 A1
(43) Pub. Date: Dec. 3, 2015

(54) System and Method for Determining Heat and Fluid Flow in or Around Objects

(71) Applicant: UNIVERSITY OF WINDSOR, Windsor (CA)

(72) Inventor: Ronald BARRON, Windsor (CA)

(21) Appl. No.: 14/723,882

(22) Filed: May 28, 2015

Related U.S. Application Data
(60) Provisional application No. 62/006,556, filed on Jun. 2, 2014.

(51) Int. Cl. G06F 17/50; G06F 17/13

(52) U.S. Cl. CPC G06F 17/5018; G06F 17/13

(57) ABSTRACT

A system includes a processor with stored instructions for generating a Cartesian mesh model of a bounded or unbounded object domain. The model includes active, inactive and boundary nodes which encompass the domain. The processor effects of discretizing a partial differential equation based on a stencil associated with each active node in the mesh by (i) selecting an active node, (ii) identifying the stencil associated with the selected node, (iii) mapping the stencil from the physical domain to a generic uniform computational stencil, (iv) applying finite difference formulas on the computational stencil to approximate the partial differential equation by a finite difference equation, (v) solving the finite difference equation to obtain an approximate value for the solution, and thereafter (vi) checking the iteration process for convergence. If the solution has not converged, the system repeats the aforementioned steps, or terminates the iteration process if the solution has converged, and outputs to a user the calculated data file.

### RELATED APPLICATIONS

This application claims the benefit under 35 USC §119(e) to U.S. Provisional Application No. 62/006,556, filed on Jun. 2, 2014, the contents of which are hereby incorporated by reference in their entirety.

### FIELD OF THE INVENTION

This invention relates to a system and method for modeling physical phenomena such as internal conditions and/or boundary conditions, as for example to model or determine fluid flows in, around and/or across objects or structures and, in particular, a system and method which operates to provide a numerical solution of partial differential equations (PDEs).

### BACKGROUND OF THE INVENTION

Computer methods and algorithms which use partial differential equations to analyze and solve complex systems involving various forms of fluid dynamics having input boundary conditions are known. Computer modeling may allow a user to simulate the flow of air and other gases over an object or model the flow of fluid through a pipe. Computational fluid dynamics (CFD) is often used with high-speed computers to simulate the interaction of one or more fluids over a surface of an object defined by certain boundary conditions. Typical methods involve large systems of equations and complex computer modeling and include traditional finite difference methodology, cell-centered finite volume methodology and vertex-centered finite volume methodology, as for example are described in the inventors commonly owned U.S. patent application Ser. No. 14/207,027, filed Mar. 12, 2014, the disclosure of which is hereby incorporated in its entirety.

Current computer modeling schemes have proven limited in the form of objects they can model and require different models and algorithms for different continuum mechanics applications, such as between compressible and non-compressible fluids and deformable solids.

### SUMMARY OF THE INVENTION

The present invention provides for method and system for determining and/or modeling physical phenomena with internal conditions and/or boundary conditions, as for example, to determine or compute heat conduction and/or heat convection within fluid dynamics of compressible and/or non-compressible fluids around objects. In one particular embodiment, it is an object of this invention to provide a method and system which for example, includes a processor, a display or monitor and programme instructions operable to compute fluid flow over or through objects. In one possible embodiment, the system may be used to compute fluid flow over aircraft components, such as airflow over aircraft wings, fuselage, landing gear, pylons and the like.

Preferably, the present system is operable to provide and display as a visual output a numerical or calculated solution to a physical phenomenon such as heat conduction or fluid flow in either bounded domains such as piping systems bounded by walls, human or animal arteries and the like; as well as unbounded solution domains, where for example, free air or liquid flows past an object.

In another embodiment, the invention provides a method and system for computing and outputting as data, graphics, or other display and/or monitor, fluid dynamics of non-compressible liquids within a pipe or transport mechanisms, as for example, through static and/or movable valves, or other components which are described with other boundary conditions.

The present invention further may provide a system and method for modeling physical phenomena such as internal fluid flows with boundary conditions of both bounded domains and unbounded domains. More preferably, the system provides for a numerical solution of partial differential equations (PDEs) which comprise a pre-processing component, a processing component and a post-processing component.

The system preferably includes a processor and memory or other suitable input means for receiving a Cartesian mesh model of a bounded or unbounded domain or object, defined as a plurality of active, inactive and boundary nodes encompassing the domain and/or object. The processor may operate in conjunction with programme instructions for implementing the steps of discretizing a partial differential equation based on a stencil associated with each node in the mesh by (i) selecting an active node, (ii) identifying the stencil associated with the selected node, (iii) mapping the stencil from the physical domain to a generic uniform computational stencil, (iv) applying finite difference formulas on the computational stencil to approximate the partial differential equation by a finite difference equation, (v) solving the finite difference equation to obtain an approximate value for the solution at the selected node, (vi) repeating the above steps for all active nodes in the mesh, (vii) checking the iteration process for convergence, (viii) repeating the above steps (i)-(vii) if the solution has not converged, or (ix) terminating the iteration process if the solution has converged, and (x) printing all calculated data to an output file.

More preferably, where the system operates to provide PDE models of a physical phenomenon occurring in a bounded domain, such as an internal fluid flow of liquid or air flow within a target object, such as piping or other passage bounded by walls, air flow in an automobile passenger compartment, flow in a pump, blood flow through arteries, or heat conduction in a solid object. A geometric, and preferably rectangular box (rectangle in 2-dimensional modeling; cube in 3-dimensional modeling) and preferably a Cartesian mesh is object-fitted wherein the mesh is superimposed or placed around the object domain, touching the domain at its extreme endpoints.

Where the system operates to provide PDE models of phenomenon occurring in unbounded solution domains, such as external fluid flow or air flow over a target object, such as an aircraft or aircraft component structures such as wings, fuselage, pylon, landing gear, etc., air flow through wind turbines, and/or river flow around bridge piers, the system operates to generate both an object-fitted internal mesh or box superimposed around the object(s), as well as a larger surrounding outer reference mesh or reference box having its sides spaced away from object-fitted mesh and the object(s) inside.

In yet a further alternate embodiment, the system and method provide for analysis and modeling of combinations of dynamic internal and external flows, such as air flow around moving road vehicles, and air flow around an aircraft during take-off or landing, and wherein the system processor is operable to generate superimposed boxes which provide mesh-structures for the solution domain using Cartesian cut-stencil based methods of finite difference solutions of PDEs.

In one preferred method, a two-dimensional Cartesian mesh for a 2D bounded object or solution domain is generated by the system processor. The computer program stored in computer memory is operated to determine the active and inactive nodes in the mesh, as well as coordinates of the boundary nodes, namely the points where the mesh lines intersect with the boundary of the solution domain. Most preferably, the computer program also includes programme instructions to identify the neighbouring nodes for each node, and to record the neighbouring node coordinates or location, such that each node P has associated with it a “stencil” centered at P, with a node identifier (i.e. such as active, inactive, boundary) and in the case where a two-dimensional mesh is generated, a set of 4 (in 2D) neighbour nodes to the west (w), south (s), east (e) and north (n).

In a three-dimensional mesh, a set of 6 (in 3D) neighbour nodes are generated, including further nodes front (f) and back (b).

If all nodes on the stencil are indicated as active nodes, then the stencil does not touch the boundary of the domain and the stencil is described as “regular” or “uncut”. If the node P is adjacent to the boundary, then at least one of its neighbour nodes is identified or recognized as being a boundary node. Preferably, the program includes instructions to determine if the boundary node lies at the intersection of a mesh horizontal grid line and a vertical grid line and if so the node is identified as a “regular” boundary node, or otherwise the node is indicated as an “irregular” boundary node.

Most preferably, for each boundary node, whether regular or irregular, the computer also includes stored program instructions operational to calculate and record an outward unit normal vector to the boundary.

Accordingly, in one aspect, the present invention resides in a computer-implemented method for approximating partial differential equations for determining fluid flow of compressible and non-compressible liquids. The method comprising of a plurality of nodes; for each node P in the plurality of nodes: (i) locating all neighbouring nodes in the Cartesian mesh that are attached directly to the node P (4 neighbouring nodes in 2D, 6 neighbouring nodes in 3D); (ii) grouping all of the neighbouring nodes to form one stencil having a central vertex at node P; (iii) mapping the said stencil from the physical domain to a generic uniform computational stencil; (iv) approximating the transformed partial differential equation(s) at the vertex of the stencil centered at node P using difference formulas to obtain the finite difference equation(s).

In another aspect, the present invention resides in a system for determining a physical phenomenon in relation to an object, and wherein the physical phenomenon is selected as being modelable by partial differential equations; input means for receiving a model of the object, the model defining the object as being contained within the Cartesian mesh comprising a plurality of active nodes, inactive nodes and boundary nodes; a processor coupled to a memory, the processor configured for implementing the steps of
A. initializing an expected solution at each said active node;
B. obtaining an approximate solution of a partial differential equation based on a stencil for each said active node by:
   i) selecting a first said active node,
   ii) identifying and mapping the stencil associated with the selected node to a generic uniform computational stencil, the computational stencil being characterized by an equal node spacing in each direction,
   iii) applying a finite difference formula at the selected node on the computational stencil to approximate the partial differential equation at the selected node by a finite difference equation,
   iv) solving the finite difference equation to obtain an approximate value of a calculated solution at the selected active node, and
   v) selecting a next active node, and repeating steps B (ii) to (iv) for each remaining said active mesh nodes.
C. comparing the calculated solution to the expected solution for each said active node to determine convergence, and where convergence is determined, outputting the solution.

In another aspect, the invention resides in a system in accordance with any of the foregoing aspects, wherein the processor further is configured whereby where convergence is not determined, select the calculated solution as a new expected solution for each said active node, and repeating steps B and C until convergence is determined.

In another aspect, the invention resides in a system in accordance with any of the foregoing aspects, further wherein the physical phenomenon comprises a fluid flow within the object; said active nodes comprise coordinates of intersecting mesh lines within the object; said inactive nodes comprise coordinates of intersecting mesh lines outside the object; and said boundary nodes comprise coordinates of intersection of mesh lines and object boundary lines.

In another aspect, the invention resides in a system in accordance with any of the foregoing aspects, further wherein the physical phenomenon comprises a heat transfer within the object; said active nodes comprise coordinates of intersecting mesh lines within the object; said inactive nodes comprise coordinates of intersecting mesh lines outside the object; and said boundary nodes comprise coordinates of intersection of mesh lines and object boundary lines.

In another aspect, the invention resides in a system in accordance with any of the foregoing aspects, further wherein said physical phenomenon comprises a fluid flow about the object; said active nodes comprise coordinates of intersecting mesh lines outside the object; said inactive nodes comprise coordinates of intersecting mesh lines within the object; and said boundary nodes comprise coordinates of intersection of mesh lines and object boundary lines.

In another aspect, the invention resides in a system in accordance with any of the foregoing aspects, further wherein the input means is for receiving a reference boundary surrounding and spaced a distance from the object, wherein the active nodes comprise intersecting mesh line nodes outside the object and within the reference boundary.

In another aspect, the invention resides in a system in accordance with any of the foregoing aspects, further wherein said Cartesian mesh comprises a uniform object-fitted Cartesian grid.

In another aspect, the invention resides in a system in accordance with any of the foregoing aspects, further wherein the Cartesian mesh is selected as a non-uniformly spaced object-fitted grid, wherein the mesh spacing is selectively biased by proximity to object boundary lines.

In another aspect, the invention resides in a system in accordance with any of the foregoing aspects, further wherein the step of solving comprises, wherein if each neighboring node is an active node, assigning the solution at each neighboring node as the expected solution.

In another aspect, the invention resides in a system in accordance with any of the foregoing aspects, further wherein the step of solving comprises, wherein if each neighboring node is an active node, assigning the solution at each neighboring node as the expected solution.

In another aspect, the invention resides in a system in accordance with any of the foregoing aspects, further wherein the step of solving further comprises, if a said neighboring node is a boundary node, assigning the solution at the boundary node as a known boundary value.

In another aspect, the invention resides in a system in accordance with any of the foregoing aspects, further wherein the step of approximating the partial differential equation comprises approximating the partial differential equation at the common vertex of the stencil centered at the selected node using finite difference formulas.

In another aspect, the invention resides in a system in accordance with any of the foregoing aspects, further wherein physical phenomenon is one dimensional, and the step of mapping the stencil comprises:

applying mapping of the selected active node P at coordinate x_{P} and next adjacent neighbour nodes at coordinates x_{W}, x_{E} in accordance with formula (1).

x=a₂ξ²+a₁ξ+a₀ (1)
where
   a₂=(x_{W}−2x_{P}+x_{E})/2=x″/2
   a₁=(x_{E}−x_{W})/2=x′
   a₀=x_{P}

In another aspect, the invention resides in a system in accordance with any of the foregoing aspects, further wherein the physical phenomenon is two dimensional, and the step of mapping the stencil comprises:

applying mapping of the selected active node P at coordinates (x_{P}, y_{P}) and next adjacent neighbor nodes at coordinates (x_{W}, y_{W}), (x_{E}, y_{E}), (x_{S}, y_{S}), (x_{N}, y_{N}) in accordance with formula (2):

x=a₂ξ²+a₁ξ+a₀

y=b₂η²+b₁η+b₀ (2)
where
   a₂=(x_{W}−2x_{P}+x_{E})/2=x″/2 b₂=(y_{S}−2y_{P}+y_{N})/2=y″/2
   a₁=(x_{E}−x_{W})/2=x′ b₁=(y_{N}−y_{S})2=y′
   a₀=x_{P} b₀=y_{P}

In another aspect, the invention resides in a system in accordance with any of the foregoing aspects, further wherein the physical phenomenon is three dimensional, and the step of mapping the stencil comprises:

applying mapping of the selected node P at coordinates (x_{P}, y_{P}, z_{P}) and next adjacent neighbor nodes at coordinates (x_{W}, y_{W}, z_{W}), (x_{E}, y_{E}, z_{E}), (x_{S}, y_{S}, z_{S}), (x_{N}, y_{N}, z_{N}), (x_{F}, y_{F}, z_{F}), (x_{B}, y_{B}, z_{B}) in accordance with formula (3):

x=a₂ξ²=a₁ξ+a₀

y=b₂η²=b₁η+b₀

z=c₂ζ²+c₁ζ+c₀ (3)
where
   a₂=(x_{W}−2x_{P}+x_{E})/2=x″/2 b₂=(y_{S}−2y_{P}+y_{N})/2=y″/2
   c₂=(z_{F}−2z_{P}+z_{B})/2=z″/2
   a₁=(x_{E}−x_{W})/2=x′ b₁=(y_{N}−y_{S})/2=y′
   c₁=(z_{B}−z_{F})/2=z′
   a₀=x_{P} b₀=y_{P} c₀=z_{P}

In another aspect, the invention resides in a system in accordance with any of the foregoing aspects, further wherein the output solution is provided independently of mesh cell flux, mesh cell area and/or mesh cell boundary calculation.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings, in which:

FIG. 1 shows schematically a system for modeling flow dynamics or other physical phenomena using a computer system in accordance with a preferred embodiment of the present invention;

FIG. 2 illustrates graphically, the identification of solution domains using the computer of FIG. 1 in modeling both the internal flow in bounded domains and the external flow in unbounded domains in accordance with a preferred method;

FIG. 3 illustrates graphically the computer generation of a Cartesian mesh in a two-dimension bounded solution domain, and the identification of inactive, active and boundary nodes, generated for predicting internal flow in accordance with a preferred embodiment;

FIG. 4 illustrates schematically the mapping of a general two-dimensional stencil associated with Cartesian mesh nodes shown in FIG. 3, to a generic uniform computational stencil;

FIGS. 5 and 6 illustrate the cut-stencil mapping for a one-dimensional non-uniform cut stencil with arms of arbitrary length, and for an interval containing many non-uniform one-dimensional stencils;

FIG. 7 illustrates schematically the application of an iterative algorithm for time-dependent ordinary differential equation resulting from the discretization of the partial differential equation(s);

FIGS. 8 to 10 illustrate graphically sample data outputs using the cut-stencil method of the current invention;

FIG. 11 illustrates the formulation of a fourth-order solution scheme using the cut-stencil approach of the present invention;

FIG. 12 shows graphically data output solutions obtained using second-order and fourth-order formulation schemes using the current invention, in comparison to an exact solution;

FIG. 13 illustrates graphically determined local truncation errors using second-order and fourth-order formulation schemes of the current invention;

FIGS. 14 and 15 illustrates graphically the results of an adaptive mesh procedure developed based on local truncation error calculations in accordance with the present invention; and

FIG. 16 gives a 2D illustration of the essential difference between the use of cut stencils, which is the subject of this invention, and cut cells which are used in Finite Volume and Finite Element methods.

### DETAILED DESCRIPTION OF THE PREFERRED EMBODIMENTS

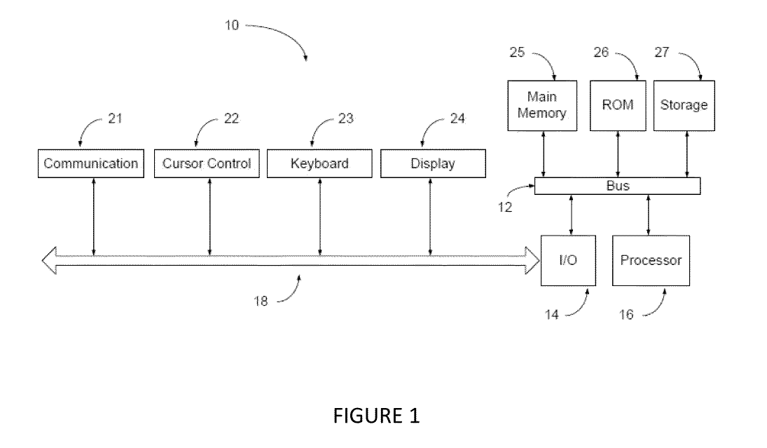

FIG. 1 illustrates schematically a system 10 for determining or the predicted modelling of compressible and non-compressible fluids in accordance with a preferred embodiment of the invention. The system 10 includes a computer which includes main memory 25, read only memory 26, and storage memory 27. A bus 12 provides electronic communication between the main memory 25 ROM, 26 and storage memory 27, and the computer processor 16 and I/O board 14.

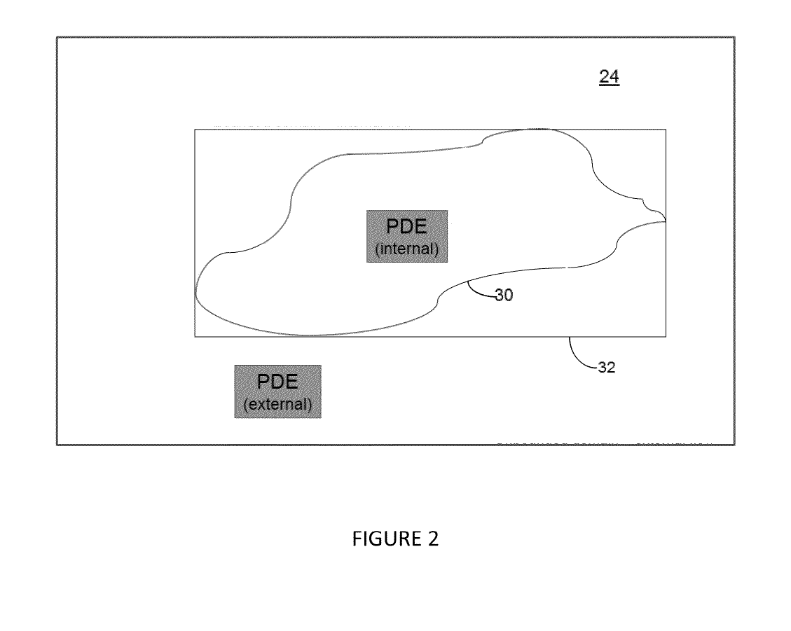

The I/O board 14 communicates via a suitable data connector 18 with the user operable keyboard 23, video display 24 and cursor control 22. In addition secondary communication output 21 may also be provided. The processor 16 stores computer program instructions which in operation of the system 10 are adapted to provide and output to a user a graphic and/or data output on the display 24, which simulates fluid flow dynamics through and/or around physical boundary defining target object 30 (see for example FIG. 2).

As will be described, in use of the system 10, the user enters into the computer memory 25 object modeling parameters such as computer aided design (CAD) model of the target object 30, boundary conditions and/or fluid properties or conditions by way of the key board 23, PDA or other suitable input 18. Optionally the modeling parameters may be displayed on the video display 24 in the manner shown in FIG. 2.

Preferred objects 30 to be modeled with the system 10 may include without limitation both two-dimensional or three-dimensional bounded structures such as pipes, arteries, and the like; as well as two-dimensional or three-dimensional unbounded domains such as external structures, river beds and the like. The system 10 may thus be used to model external and internal fluid or air flow around buildings, road vehicles or aircraft components, as well as flow along pipes. In an alternate embodiment, the present system 10 may also be used to predict and/or model heat flow or heat conduction through objects and/or liquids.

The system 10 of the present invention provides for the numerical solution of partial differential equations (PDEs) which comprises pre-processing, processing and post-processing components.

FIG. 2 shows a sample finite rectangular domain 32 used in the PDE modelling of a two-dimensional bounded domain system for the object 30. In particular, the computer processor 16 operates to generate and superimpose a rectangular box 32 around the selected solution domain or domain of interest for the object 30. The generated box 32 has a dimension selected to contact or touch the selected domain of interest on multiple sides, and preferably at each of its top, bottom and extreme endpoints.

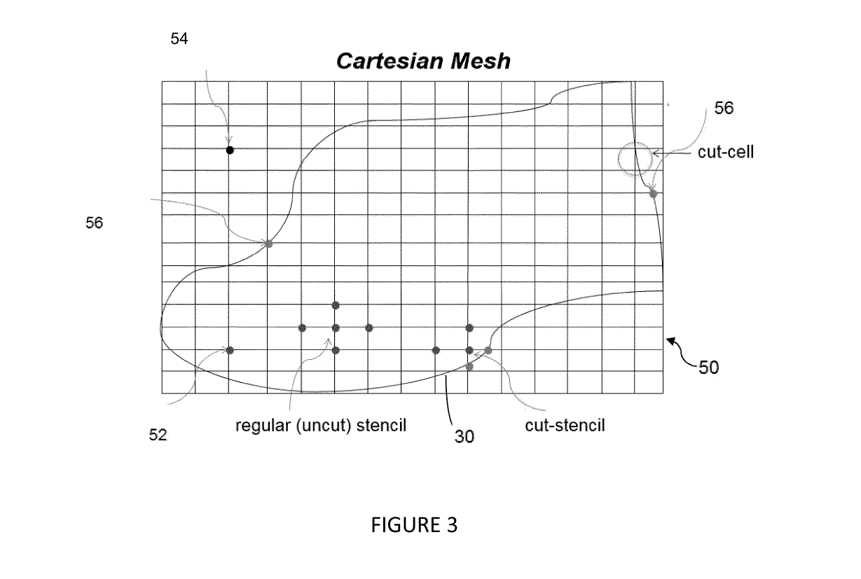

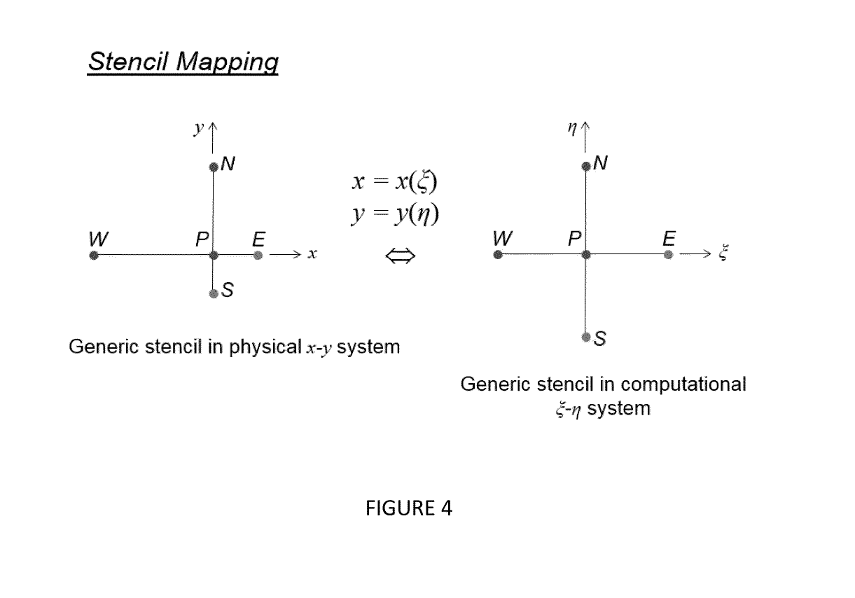

FIG. 3 shows the construction of a Cartesian mesh 50 for a 2D bounded solution domain. The computer processor 16 includes computer program having stored instructions operational to determine the active and inactive nodes 52, 54 in the mesh 50, as well as the coordinates of the boundary nodes 56, namely, points where the mesh lines intersect with the boundary of the domain of interest. Most preferably, the computer program also identifies the neighbouring nodes for each node and records their coordinates (location). In this way, each node P has associated with it a “stencil” centered at P, with a node ID or identifier (active, inactive, boundary) and a set of 4 (in 2D) neighbour nodes to the west (W), south (S), east (E) and north (N), as for example are shown in FIG. 4.

If all nodes on the stencil are active nodes, then the stencil does not touch the boundary of the domain and the stencil is described as “regular” or “uncut.” If the node P is adjacent to the boundary, then at least one of its neighbours will be a boundary node. If the boundary node lies at the intersection of a horizontal grid line and a vertical grid line, the node is called a “regular” boundary node, otherwise it is an “irregular” boundary node.

For all boundary nodes, whether regular or irregular, the computer program also calculates and records the outward unit normal vector to the boundary.

In the above described construction of a Cartesian mesh, the mesh intersection with a domain boundary and identification of nodes may further form a basis for the Cartesian “cut-cell” and the “embedded mesh” technologies used with Finite Volume and Finite Element codes. However, unlike conventional methods where the discretization of the PDE is based on the geometry and connectivity of the cells in the mesh, Finite Difference discretization is used in the current invention based on the stencil associated with each node in the mesh.

The inventor has further appreciated that cut-cell and embedded mesh formulations may require the computation and storage of a large amount of additional information, such as the unit normal vectors along all edges (2D) or faces (3D) of all cells (interior and cut), cell connectivity (in 2D each cell has 8 connected cells, 4 of them share an edge with the central cell, 4 share a point with the central cell), area (2D) or volume (3D) of each cell, length of each cell edge (2D) or surface area of each face (3D). In contrast, however, this additional information is not needed for the present cut-stencil method.

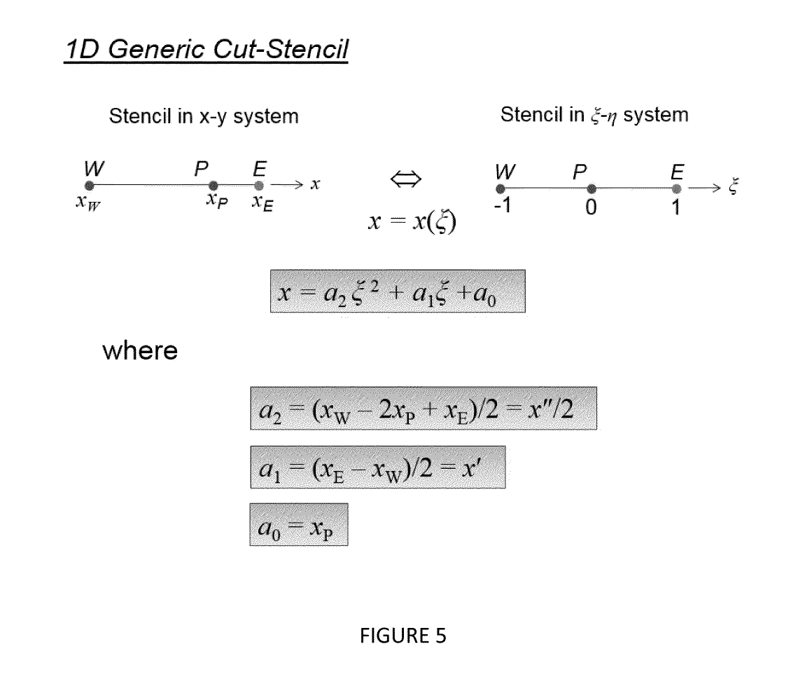

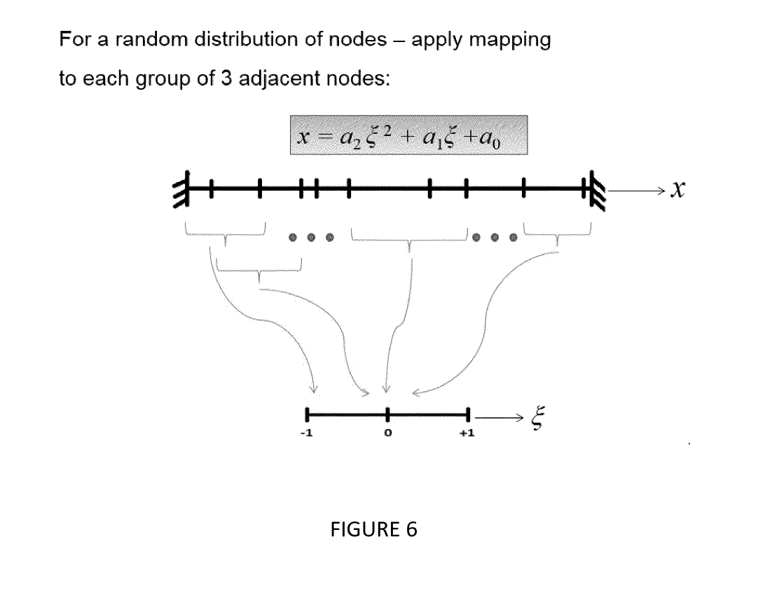

FIGS. 4 to 6 illustrate graphically the essence of the cut-stencil method in accordance with a preferred embodiment. The general idea of mapping any stencil (stencil arms may be equal or of different lengths) to a generic uniform unit stencil (arms all have unit length) is shown graphically in FIG. 4. The unique mapping that accomplishes this goal is given in FIG. 5 for the ID case, and is representative of the mappings used in both 2D and 3D application. FIG. 6 demonstrates a feature of the stencil mapping, and in particular, that each individual triplet of adjacent nodes has its own unique quadratic mapping to the uniform computational stencil. Focusing on the stencil as an entity and mapping it to a uniform computational stencil advantageously allows the treatment of cut stencils in the same way as regular stencils, allowing for a Finite Difference discretization of the PDE on any domain, irrespective of its complexity.

It is noted that coordinate mappings are also sometimes used in numerical solutions of PDEs. Such mappings are, however, defined by mathematical functions that maps all logically connected nodes in the physical domain into a set of evenly distributed nodes in a computational domain. As such, the use of a single mapping function limits the ability to deal with highly complex domains.

The general one-dimensional convection-diffusion equation often used by researchers to test their numerical formulations and solution algorithms is as follows:

$$\frac{\partial ϕ}{\partial t} {\vert}_{P} - Γ [ \frac{1}{{x}_{P}^{{′}^{2}}} \frac{{\partial }^{2} ϕ}{\partial {ξ}^{2}} {\vert}_{P} - \frac{{x}_{P}^{″}}{{x}_{P}^{{′}^{3}}} \frac{\partial ϕ}{\partial ξ} {\vert}_{P} ] + \frac{u}{{x}_{P}^{′}} \frac{\partial ϕ}{\partial ξ} {\vert}_{P} = {S}_{p} \qquad$$

The equation shown above is the 1D version, but extensions to 2D and 3D are straightforward and understood. Transformation of the convection-diffusion equation to the computational stencil centered at node P is illustrated as follows:

Convection-Diffusion equation at node P transforms to

$$\frac{\partial ϕ}{\partial t} - Γ \frac{{\partial }^{2} ϕ}{\partial {x}^{2}} + u \frac{\partial ϕ}{\partial x} = S$$

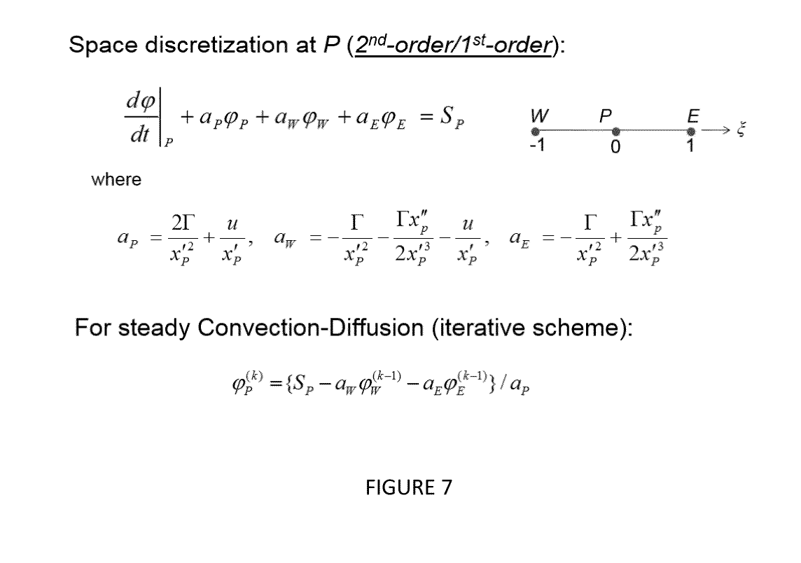

The time-dependent ordinary differential equation resulting from space discretization of the above equation is shown in FIG. 7, and an iterative algorithm is given for the steady (time-independent) case.

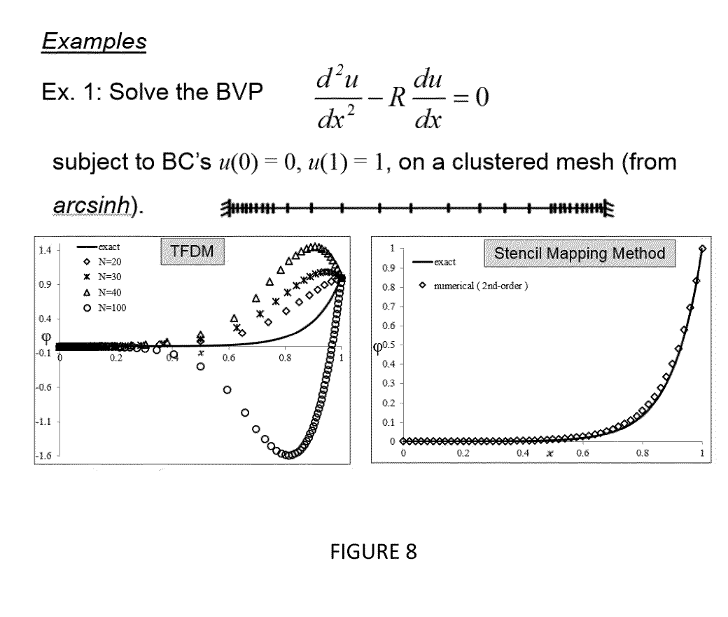

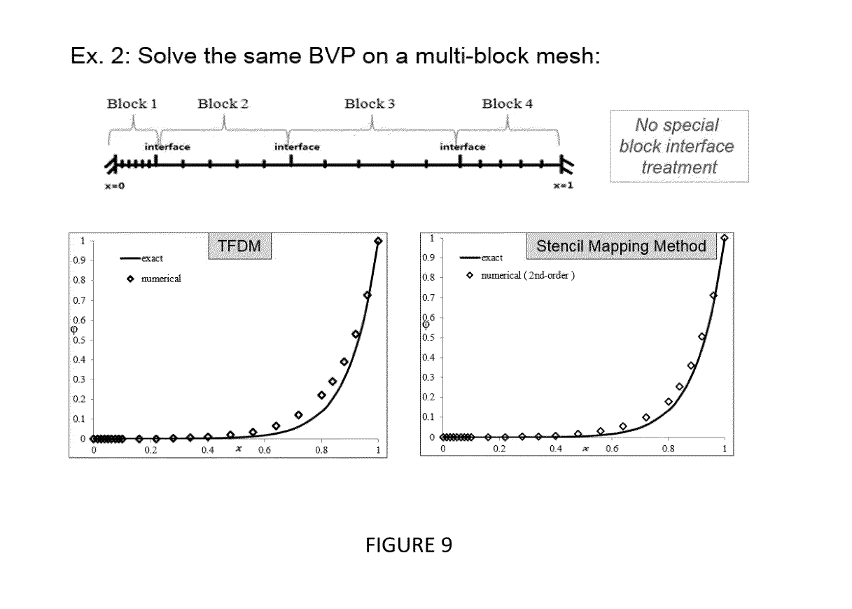

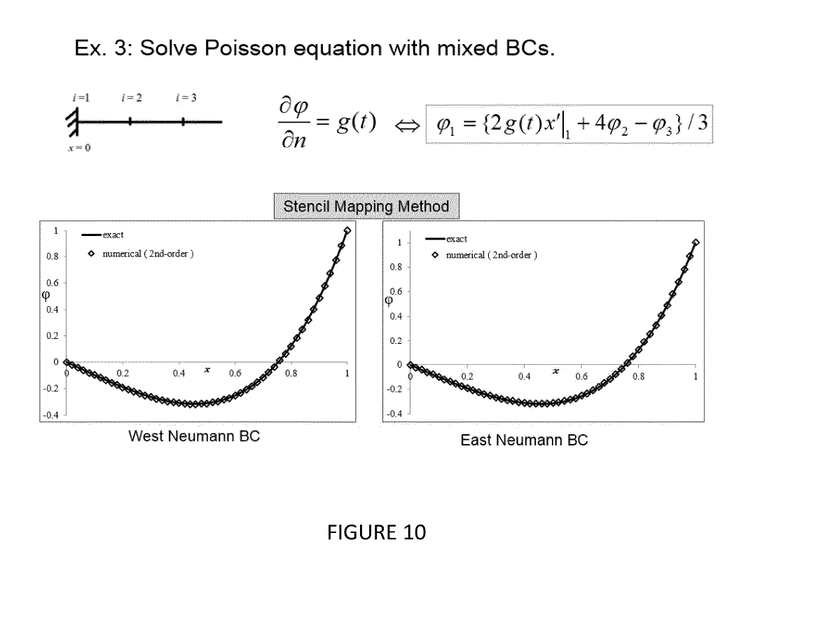

FIGS. 8 to 10 illustrate examples of calculations using the cut-stencil methodology in accordance with the present invention, and demonstrate graphically the strength and capabilities of the current system.

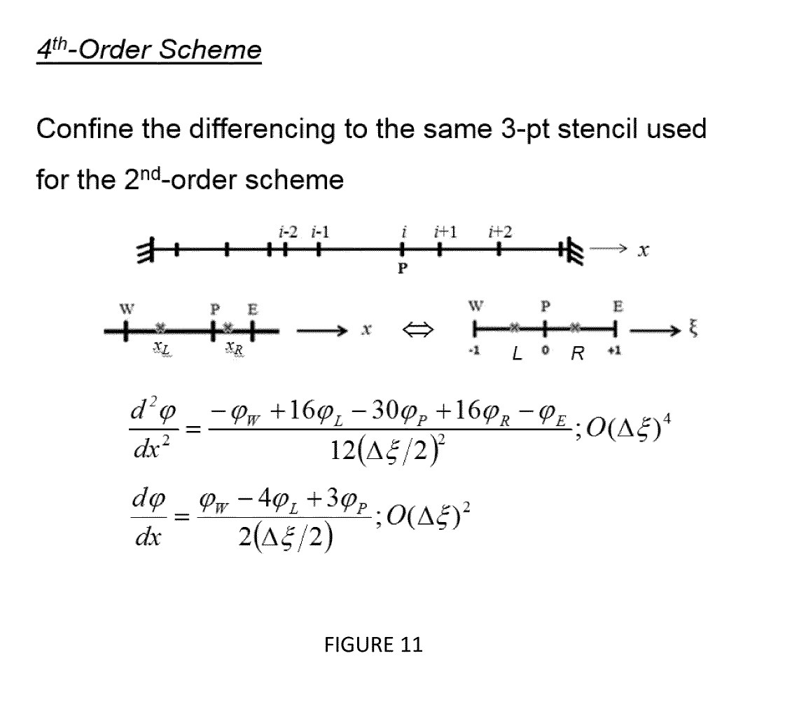

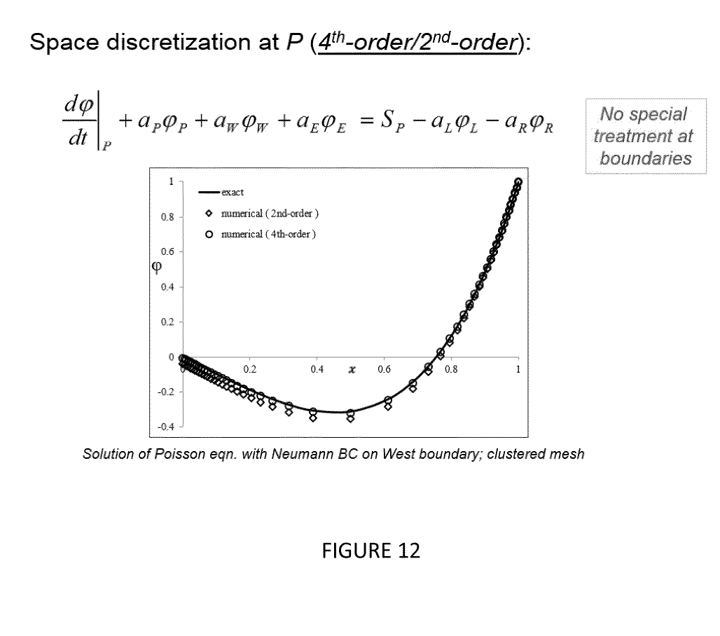

The cut-stencil approach is a convenient framework from which to develop high-order solution schemes. Formulation of the 4^{th}-order scheme is illustrated graphically in FIG. 11. A comparison between the 4^{th}-order, 2^{nd}-order and exact solutions are shown in FIG. 12.

Two important features of the cut-stencil method should be noted: 1) from a formulation perspective, one can easily devise 8^{th}-order, 16^{th}-order and higher-order schemes. 2) Secondly, there is no loss of accuracy at nodes adjacent to the boundary since they are treated in the same way as interior nodes. This is a significant improvement over all existing methods which use a high-order scheme at interior nodes, but must use a lower-order scheme at the boundary, thereby degrading the overall accuracy of the solution.

Formulae for the local truncation errors (LTE) are easily derived in a Finite Difference approach. For the Finite Volume and Finite Element approaches, researchers have developed error estimates, but these serve only as approximations to the true error. Using the Taylor series expansion at node P in the discretized equation gives the modified differential equation, which provides an expression of the leading terms in the local truncation error (LTE), e.g., for steady convection-diffusion. Local truncation errors for second and fourth order schemes may be estimated as follows:

$${2}^{nd} \text{-} order scheme$$

$$L . T . E . = \frac{R}{2 {x}_{P}^{′}} \frac{{d}^{2} {ϕ}_{P}}{d {ξ}^{2}} - \frac{{x}_{P}^{″}}{6 {x}_{P}^{′3}} \frac{{d}^{3} {ϕ}_{P}}{d {ξ}^{3}} - \frac{R}{6 {x}_{P}^{′}} \frac{{d}^{3} {ϕ}_{P}}{d {ξ}^{3}} + \frac{1}{12 {x}_{P}^{′2}} \frac{{d}^{4} {ϕ}_{P}}{d {ξ}^{2}} \qquad$$

$${4}^{th} \text{-} order scheme$$

$$L . T . E . = \begin{matrix}\frac{1}{1440 {x}_{P}^{′2}} \frac{{d}^{6} {ϕ}_{P}}{d {ξ}^{6}} - \frac{R}{768 {x}_{P}^{′}} \frac{{d}^{6} {ϕ}_{P}}{d {ξ}^{6}} + \frac{{x}_{P}^{″}}{480 {x}_{P}^{′3}} \frac{{d}^{5} {ϕ}_{P}}{d {ξ}^{5}} - \\ \frac{7 R}{960 {x}_{P}^{′}} \frac{{d}^{5} {ϕ}_{P}}{d {ξ}^{5}} - \frac{R}{32 {x}_{P}^{′}} \frac{{d}^{4} {ϕ}_{P}}{d {ξ}^{4}} + \frac{R}{12 {x}_{P}^{′}} \frac{{d}^{3} {ϕ}_{P}}{d {ξ}^{3}}\end{matrix} \qquad$$

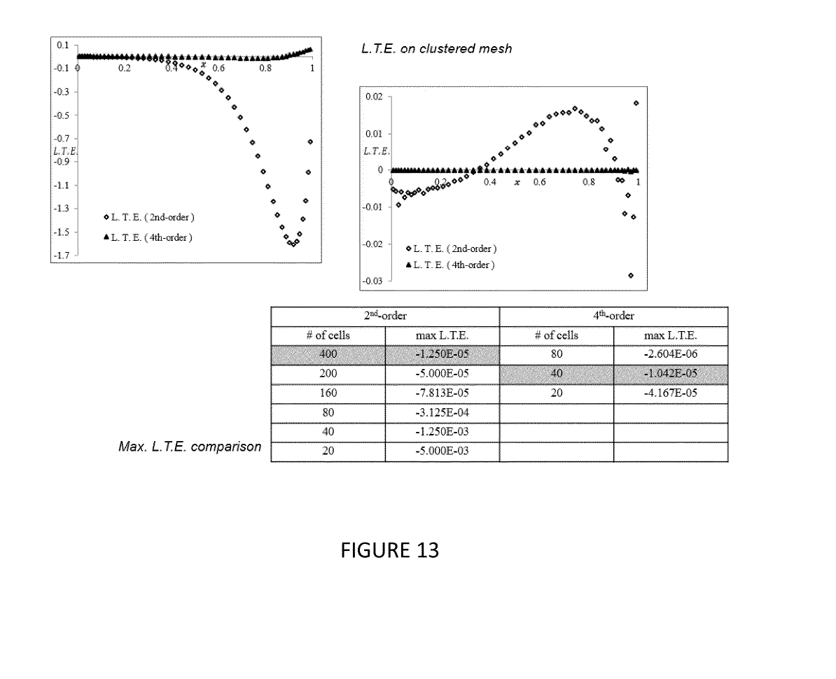

FIG. 13 shows graphically the LTE by means of the aforementioned formula, and illustrates one use of the LTE, to compare the accuracy of schemes of different orders. The table shown in FIG. 13 suggests that a prescribed level of accuracy can be achieved with much fewer nodes in a 4^{th}-order scheme (i.e. 40 cells) compared to a 2^{nd}-order scheme (i.e. 400 cells), i.e. a ratio of 1 to 10. Some 2D tests have shown that the ratio may be even more dramatic, at 1 to 100. This is significant since a typical industrial simulation may require 20,000,000 nodes or more for a 2^{nd}-order scheme (some researchers are using more than 1 billion nodes). Such computations are very expensive, requiring large computing resources, 1000's of CPU hours and long run times. The higher-order schemes based on the cut-stencil approach have the potential to reduce these calculations, thereby reducing demands on computer resources and shortening run times.

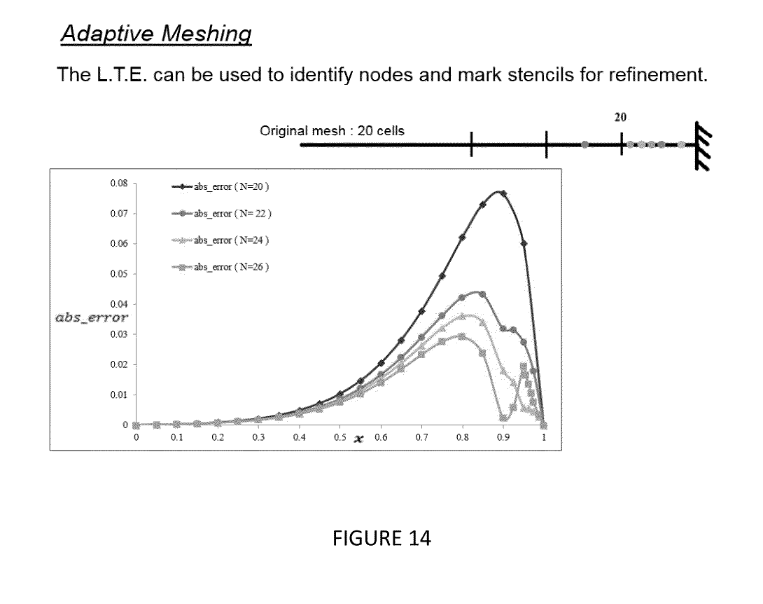

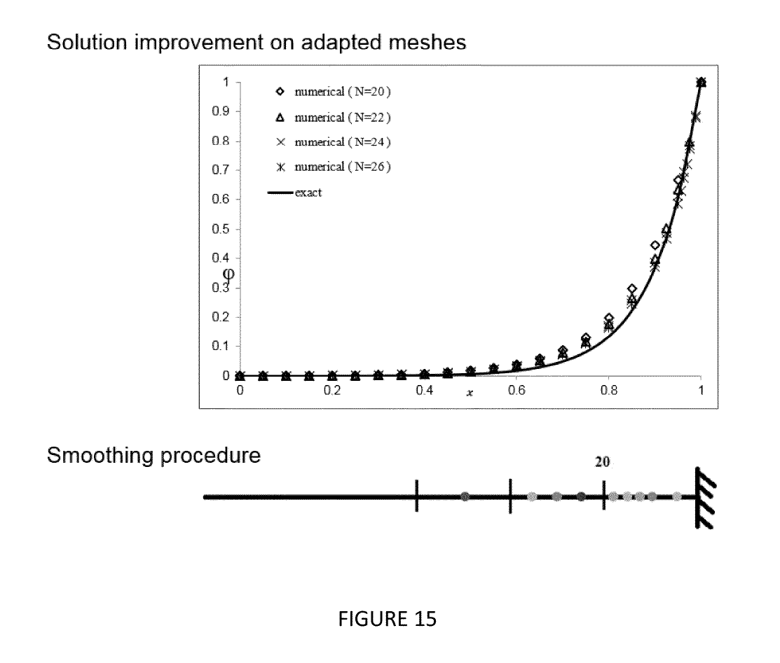

The cut-stencil method is ideally suited for mesh adapting. FIGS. 14 and 15 show graphically the results of an adaptive mesh procedure that has been developed based on the LTE. Existing adaptive mesh methods are generally based on error estimates or solution gradients, which are not as predictive of the mesh region requiring adapting as the LTE is.

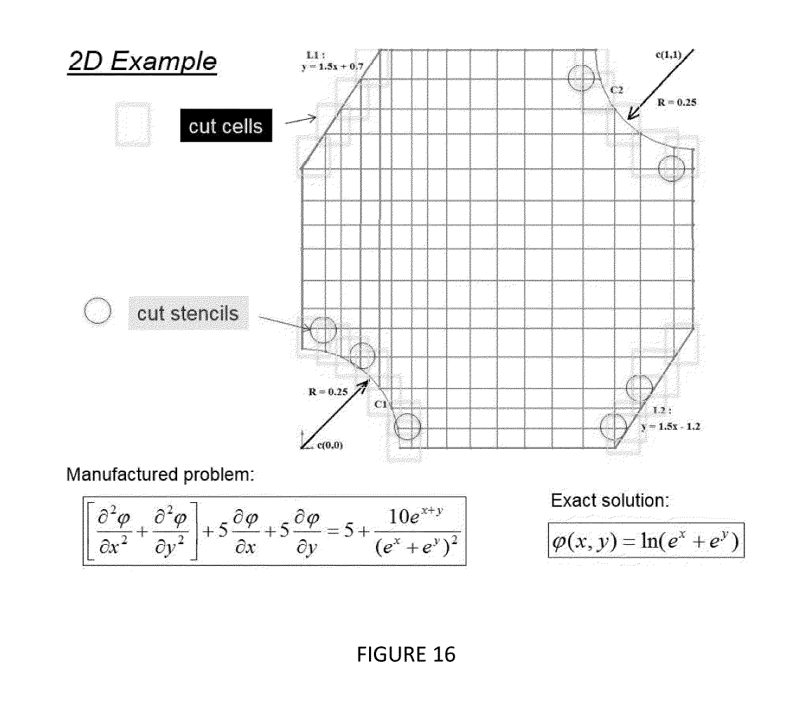

FIG. 16 shows graphically an application of the cut-stencil method in 2D. The domain shown in FIG. 16 cannot be solved by traditional finite difference, due to the cut stencils around the boundary. As illustrated with reference to FIG. 16, the domain can be solved using Finite Volume or Finite Element, but the solution procedures are much more complicated than the cut-stencil method.

The solution provided by the present invention shows promising results with reduced relative errors and processing requirements, as for example the solution of the problem shown in FIG. 16, as reflected in the following Table 1:

TABLE 1
Relative Error (N = 242)

| | | %(Rel. | %(Rel. |
|---|---|---|---|
| | Boundary | error)_{Avg.} at | error)_{Max.} at |
| Equation | condition | internal nodes | internal nodes |
| Diffusion | Dirichlet | 0.021% | 0.040% |
| | (all) | | |
| Diffusion | Neumann | 0.023% | 0.041% |
| | (West & South) | | |
| Diff.- Conv. | Dirichlet | 0.012% | 0.031% |
| (central) | (all) | | |
| Diff.- Conv. | Neumann | 0.013% | 0.030% |
| (central ) | (West & South) | | |
| Diff.- Conv. | Dirichlet | 0.345% | 0.873% |
| (central/upwind) | (all) | | |

Although the detailed description describes and illustrates various preferred embodiments and methods, the invention is not strictly limited to the best mode of the invention which is described. Variations and modifications will now occur to persons skilled in the art. For a definition of the invention, reference may be had to the appended claims.

We claim:

1. A system for determining a physical phenomenon in relation to an object, and wherein the physical phenomenon is selected as being modelable by partial differential equations;
input means for receiving a model of the object, the model defining the object as being contained within the Cartesian mesh comprising a plurality of active nodes, inactive nodes and boundary nodes;
a processor coupled to a memory, the processor configured for implementing the steps of
A. initializing an expected solution at each said active node;
B. obtaining an approximate solution of a partial differential equation based on a stencil for each said active node by:
i) selecting a first said active node,
ii) identifying and mapping the stencil associated with the selected node to a generic uniform computational stencil, the computational stencil being characterized by an equal node spacing in each direction,
iii) applying a finite difference formula at the selected node on the computational stencil to approximate the partial differential equation at the selected node by a finite difference equation,
iv) solving the finite difference equation to obtain an approximate value of a calculated solution at the selected active node, and
v) selecting a next active node, and repeating steps B (ii) to (iv) for each remaining said active mesh nodes.
C. comparing the calculated solution to the expected solution for each said active node to determine convergence, and where convergence is determined, outputting the solution.

2. The system as claimed in claim 1, wherein the processor further is configured whereby where convergence is not determined, select the calculated solution as a new expected solution for each said active node, and repeating steps B and C until convergence is determined.

3. The system as claimed in claim 2, wherein the physical phenomenon comprises a fluid flow within the object;
said active nodes comprise coordinates of intersecting mesh lines within the object;
said inactive nodes comprise coordinates of intersecting mesh lines outside the object; and
said boundary nodes comprise coordinates of intersection of mesh lines and object boundary lines.

4. The system as claimed in claim 2, wherein the physical phenomenon comprises a heat transfer within the object;
said active nodes comprise coordinates of intersecting mesh lines within the object;
said inactive nodes comprise coordinates of intersecting mesh lines outside the object; and
said boundary nodes comprise coordinates of intersection of mesh lines and object boundary lines.

5. The system as claimed in claim 2, wherein said physical phenomenon comprises a fluid flow about the object;
said active nodes comprise coordinates of intersecting mesh lines outside the object;
said inactive nodes comprise coordinates of intersecting mesh lines within the object; and
said boundary nodes comprise coordinates of intersection of mesh lines and object boundary lines.

6. The system as claimed in claim 5, further wherein the input means is for receiving a reference boundary surrounding and spaced a distance from the object, wherein the active nodes comprise intersecting mesh line nodes outside the object and within the reference boundary.

7. The system as claimed in claim 1, wherein said Cartesian mesh comprises a uniform object-fitted Cartesian grid.

8. The system as claimed in claim 1, wherein the Cartesian mesh is selected as a non-uniformly spaced object-fitted grid, wherein the mesh spacing is selectively biased by proximity to object boundary lines.

9. The system of claim 1, wherein the step of solving comprises, wherein if each neighboring node is an active node, assigning the solution at each neighboring node as the expected solution.

10. The system of claim 2, wherein the step of solving comprises, wherein if each neighboring node is an active node, assigning the solution at each neighboring node as the expected solution.

11. The system of claim 10, wherein the step of solving further comprises, if a said neighboring node is a boundary node, assigning the solution at the boundary node as a known boundary value.

12. The system as claimed in claim 11, wherein the step of approximating the partial differential equation comprises approximating the partial differential equation at the common vertex of the stencil centered at the selected node using finite difference formulas.

13. The system as claimed in claim 1, wherein the physical phenomenon is one dimensional, and the step of mapping the stencil comprises:
applying mapping of the selected active node P at coordinate x_{P} and next adjacent neighbour nodes at coordinates x_{W}, x_{E} in accordance with formula (1).
x=a₂ξ²+a₁ξ+a₀ (1)
where
a₂=(x_{W}−2x_{P}+x_{E})/2=x″/2
a₁=(x_{E}−x_{W})/2=x′
a₀=x_{P}

14. The system as claimed in claim 1, wherein the physical phenomenon is two dimensional, and the step of mapping the stencil comprises:
applying mapping of the selected active node P at coordinates (x_{P}, y_{P}) and next adjacent neighbor nodes at coordinates (x_{W}, y_{W}), (x_{E}, y_{E}), (x_{S}, y_{S}), (x_{N}, y_{N}) in accordance with formula (2):
x=a₂ξ²+a₁ξ+a₀
y=b₂η²+b₁η+b₀ (2)
where
a₂=(x_{W}−2x_{P}+x_{E})/2=x″/2 b₂=(y_{S}−2y_{P}+y_{N})/2=y″/2
a₁=(x_{E}−x_{W})/2=x′ b₁=(y_{N}−y_{S})2=y′
a₀=x_{P} b₀=y_{P}

15. The system as claimed in claim 1, wherein the physical phenomenon is three dimensional, and the step of mapping the stencil comprises:
applying mapping of the selected node P at coordinates (x_{P}, y_{P}, z_{P}) and next adjacent neighbor nodes at coordinates (x_{W}, y_{W}, z_{W}), (x_{E}, y_{E}, z_{E}), (x_{S}, y_{S}, z_{S}), (x_{N}, y_{N}, z_{N}) (x_{F}, y_{F}, z_{F}), (x_{B}, y_{B}, z_{B}) in accordance with formula (3):
x=a₂ξ²=a₁ξ+a₀
y=b₂η²=b₁η+b₀
z=c₂ζ²+c₁ζ+c₀ (3)
where
a₂=(x_{W}−2x_{P}+x_{E})/2=x″/2 b₂=(y_{S}−2y_{P}+y_{N})/2=y″/2
c₂=(z_{F}−2z_{P}+z_{B})/2=z″/2
a₁=(x_{E}−x_{W})/2=x′ b₁=(y_{N}−y_{S})/2=y′
c₁=(z_{B}−z_{F})/2=z′
a₀=x_{P} b₀=y_{P} c₀=z_{P}

16. The system as claimed in claim 11, wherein the physical phenomenon is one dimensional, and the step of mapping the stencil comprises:
applying mapping of the selected active node P at coordinate x_{P} and next adjacent neighbour nodes at coordinates x_{W}, x_{E} in accordance with formula (1).
x=a₂ξ²+a₁ξ+a₀ (1)
where
a₂=(x_{W}−2x_{P}+x_{E})/2=x″/2
a₁=(x_{E}−x_{W})/2=x′
a₀=x_{P}

17. The system as claimed in claim 11, wherein the physical phenomenon is two dimensional, and the step of mapping the stencil comprises:
applying mapping of the selected active node P at coordinates (x_{P}, y_{P}) and next adjacent neighbor nodes at coordinates (x_{W}, y_{W}), (x_{E}, y_{E}), (x_{S}, y_{S}), (x_{N}, y_{N}) in accordance with formula (2):
x=a₂ξ²+a₁ξ+a₀
y=b₂η²+b₁η+b₀ (2)
where
a₂=(x_{W}−2x_{P}+x_{E})/2=x″/2 b₂=(y_{S}−2y_{P}+y_{N})/2=y″/2
a₁=(x_{E}−x_{W})/2=x′ b₁=(y_{N}−y_{S})2=y′
a₀=x_{P} b₀=y_{P}

18. The system as claimed in claim 1, wherein the physical phenomenon is three dimensional, and the step of mapping the stencil comprises:
applying mapping of the selected node P at coordinates (x_{P}, y_{P}, z_{P}) and next adjacent neighbor nodes at coordinates (x_{W}, y_{W}, z_{W}), (x_{E}, y_{E}, z_{E}), (x_{S}, y_{S}, z_{S}), (x_{N}, y_{N}, z_{N}), (x_{F}, y_{F}, z_{F}), (x_{B}, y_{B}, z_{B}) in accordance with formula (3):
x=a₂ξ²=a₁ξ+a₀
y=b₂η²=b₁η+b₀
z=c₂ζ²+c₁ζ+c₀ (3)
where
a₂=(x_{W}−2x_{P}+x_{E})/2=x″/2 b₂=(y_{S}−2y_{P}+y_{N})/2=y″/2
c₂=(z_{F}−2z_{P}+z_{B})/2=z″/2
a₁=(x_{E}−x_{W})/2=x′ b₁=(y_{N}−y_{S})/2=y′
c₁=(z_{B}−z_{F})/2=z′
a₀=x_{P} b₀=y_{P} c₀=z_{P}

19. The system as claimed claim 1, wherein the output solution is provided independently of mesh cell flux, mesh cell area and/or mesh cell boundary calculation.

20. The system as claimed claim 17, wherein the output solution is provided independently of mesh cell flux, mesh cell area and/or mesh cell boundary calculation.
